(19) United States
(12) Patent Application Publication
(10) Pub. No.: US 2010/0171672 A1
(43) Pub. Date: Jul. 8, 2010

(54) Loop Antenna for Wireless Network

(76) Inventor: Hsiao-Ting Huang, Taichung County (TW)

Correspondence Address: NORTH AMERICA INTELLECTUAL PROPERTY CORPORATION, P.O. BOX 506, MERRIFIELD, VA, 22116, US

(21) Appl. No.: 12/479,841

(22) Filed: Jun. 7, 2009

(30) Foreign Application Priority Data
Jan. 6, 2009 (TW) 098100156

(51) Int. Cl. H01Q 11/12

(52) U.S. Cl. 343/741

(57) ABSTRACT

To improve vertical efficiency, the present invention provides a loop antenna for a wireless network, which includes a feeding terminal for receiving a feeding signal, a shorting-to-ground terminal for providing grounding, a metal bar formed on a first plane and surrounding a center point, a first metal arm formed on a second plane associated with the first plane and coupled between an terminal of the metal bar and the feeding terminal, and a second metal arm formed on a third plane associated with the first plane and coupled between another terminal of the metal bar and the shorting-to-ground terminal.

### BACKGROUND OF THE INVENTION

1. Field of the Invention

The present invention is related to a loop antenna for a wireless network, and more particularly, to a loop antenna capable of improving vertical efficiency.

2. Description of the Prior Art

In modern IT (Information Technology) society, various wireless communication networks have become one of the most important ways for exchanging voice, text, data, and video for many people. In the prior art, a computer system can access a wireless communication network via a wireless adapter through a plug-and-play interface, such as a Universal Serial Bus (USB). For example, in FIG. 1, when using a USB wireless adapter 10, a user only needs to plug the USB wireless adapter 10 into one of USB ports of a notebook. In general, the USB wireless adapter 10 is composed of an antenna and related processing units, and utilized for emitting and receiving radio waves, to transmit or receive wireless signals. Therefore, in order to allow the user to access wireless communication networks more conveniently, a size of the antenna is required to be reduced, to fit a main stream of reducing a size of a portable wireless device.

Planar Inverted-F Antenna (PIFA) is a monopole antenna commonly used in the wireless adapter. As implied in the name, a shape of PIFA is similar to an inverted and rotated “F”. PIFA has advantages of low production cost, high radiation efficiency, easily realizing multi-channel operations. However, a vertical gain of PIFA is not good enough for the example shown in FIG. 2.

A loop antenna is an electric conductor surrounded as a closed curving shape (e.g. circular, square and triangular shapes) on a plane with an operating principle similar to a dipole antenna, or a resonant antenna. Please refer to FIG. 2. FIG. 2 is a schematic diagram of a loop antenna 20 of the prior art. As shown in FIG. 2, the loop antenna 20 is a circular electric conductor formed on an x-y plane, with characteristics of low profile, such that the loop antenna 20 requires smaller forming space, to fit the application of the wireless adapter. However, the loop antenna 20 belongs to horizontal polarization. That is, a vertical gain (along a z-axis in FIG. 2) is not good and not appropriate for the example of FIG. 2, which restricts the application range.

In short, although the loop antenna has the feature of low profile, the property of horizontal polarization limits its performance in wireless network applications. Therefore, how to improve the abovementioned drawback has become a goal of the industry.

### SUMMARY OF THE INVENTION

It is therefore a primary objective of the claimed invention to provide a loop antenna for a wireless network.

The present invention discloses a loop antenna for a wireless network, which comprises a feeding terminal for receiving a feeding signal, a shorting-to-ground terminal for providing grounding, a metal bar formed on a first plane and surrounding a center point, a first metal arm formed on a second plane associated with the first plane and coupled between an terminal of the metal bar and the feeding terminal, and a second metal arm formed on a third plane associated with the first plane and coupled between another terminal of the metal bar and the shorting-to-ground terminal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless adapter applied in a notebook in the prior art.

FIG. 2 is a schematic diagram of a loop antenna of the prior art.

FIG. 3A is a schematic diagram of a loop antenna according to an embodiment of the present invention.

FIG. 3B is a schematic diagram of the current paths of the loop antenna shown in FIG. 3A.

FIG. 3C is a schematic diagram of a modification of the loop antenna shown in FIG. 3A.

FIG. 4 to FIG. 6 are schematic diagrams of loop antennas according to the embodiments of the present invention.

FIG. 7 is a schematic diagram of a wireless adapter according to an embodiment of the present invention.

FIG. 8 is a return loss diagram of the wireless adapter shown in FIG. 7.

FIG. 9A is a schematic diagram of a horizontal gain on an x-y plane of the wireless adapter shown in FIG. 7.

FIG. 9B is a schematic diagram of a vertical gain on an x-y plane of the wireless adapter shown in FIG. 7.

FIG. 9C is a schematic diagram of a total gain on an x-y plane of the wireless adapter shown in FIG. 7.

FIG. 10 is a schematic diagram of radiation efficiency of the wireless adapter shown in FIG. 7.

### DETAILED DESCRIPTION

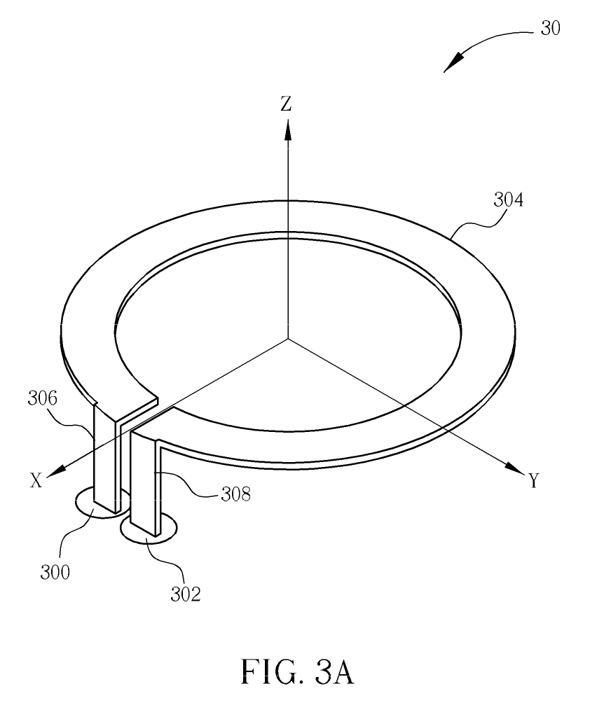

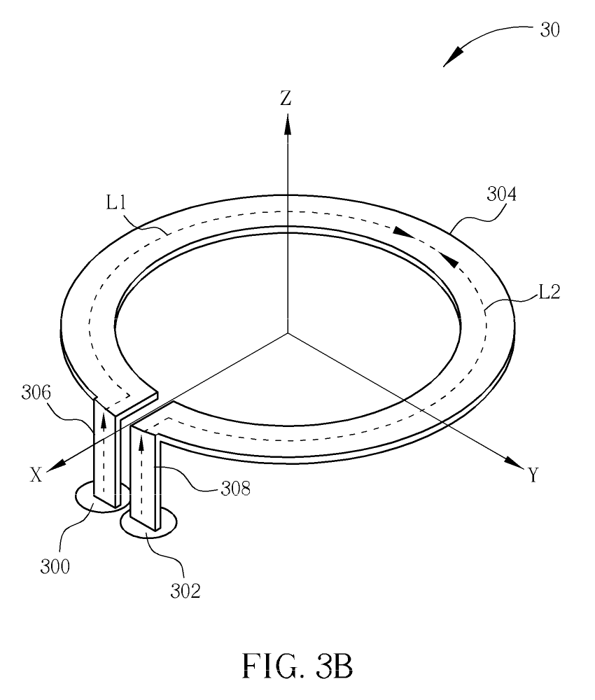

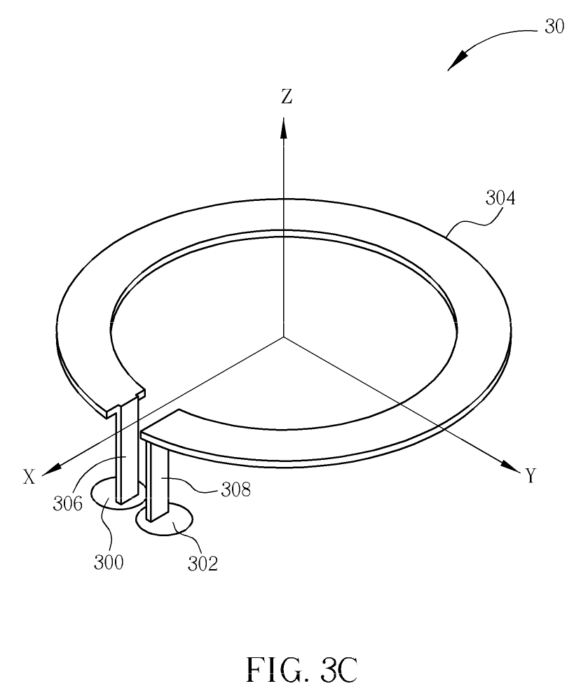

Please refer to FIG. 3A, which illustrates a schematic diagram of a loop antenna 30 according to an embodiment of the present invention. The loop antenna 30 is utilized for transmitting and receiving wireless signals of a wireless network, and comprises a feeding terminal 300, a shorting-to-ground terminal 302, a metal bar 304, a first metal arm 306, and a second metal arm 308. The feeding terminal 300 and the shorting-to-ground terminal 302 are utilized for receiving feeding signals and providing grounding respectively, and preferably formed on a printed circuit board (not shown in FIG. 3). The metal bar 304 is formed on an x-y plane and surrounds a virtual center, with two ends connecting to the feeding terminal 300 and the shorting-to-ground terminal 302 via the first metal arm 306 and the second metal arm 308 respectively. The first metal arm 306 and the second metal arm 308 both extend along a z-axis. That is, the first metal arm 306 and the second metal arm 308 are formed on a plane perpendicular to the metal bar 304.

On the other hand, a total length of the metal bar 304, the first metal arm 306 and the second metal arm 308 is preferably λ/2 (λ represents a wavelength of a feeding signal), and lengths of the first metal arm 306 and the second metal arm 308 are all 0.05λ. Under such circumstance, current paths of the loop antenna 30 can be illustrated as shown in FIG. 3B. According to the electromagnetism theorem, when high frequency (HF) signals transmit on a conductor, a resonant point, namely open circuit, is formed on a position which is a quarter wavelength apart from a feeding terminal. Therefore, in the loop antenna 30, a current L1 from the feeding terminal 300 to a center of the metal bar 304 (the position of λ/4) counterbalances or nearly cancels out a current L2 from the shorting-to-ground terminal 302 to the center of the metal bar 304. In other words, as shown in FIG. 3B, horizontal currents (on the x-y plane) nearly counterbalance each other (a small portion of currents along the x axis still exist), and vertical currents dominate radiation of an electric field. Since a radiating direction of the electric field is parallel to the direction of current flow, the vertical currents enhance a vertical gain, making the loop antenna 30 become vertically polarized.

In short, since the total length of the metal bar 304, the first metal arm 306 and the second metal arm 308 is λ/2, an open circuit is formed on the center of the metal bar 304 and (nearly) counterbalances horizontal currents. Meanwhile, by forming the first metal arm 306 and the second metal arm 308 on the plane perpendicular to the metal bar 304, there are only the vertical currents in the loop antenna 30, which enhances the vertical gain to reach the goal of vertical polarization.

Note that, a total length of the loop antenna 30 is not limited to λ/2. Designs, which can (nearly) counterbalance the horizontal currents and make currents of the first metal arm 306 and the second metal arm 308 to flow in the same direction, conform to the inventive concept of the present invention. For instance, in FIG. 3C, the first metal arm 306 and the second metal arm 308 are formed face to face, and the horizontal currents can also be counterbalanced to enhance the vertical gain.

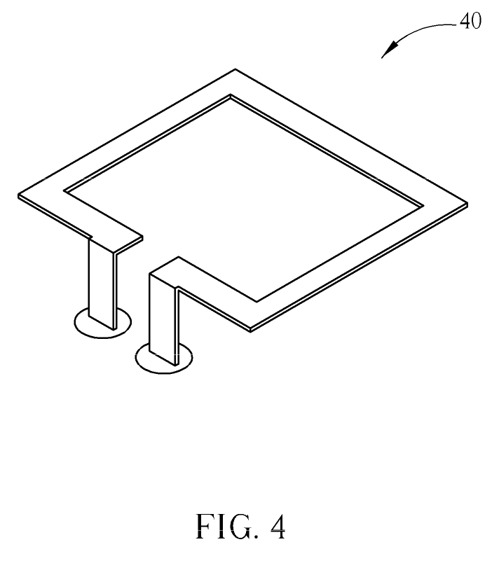

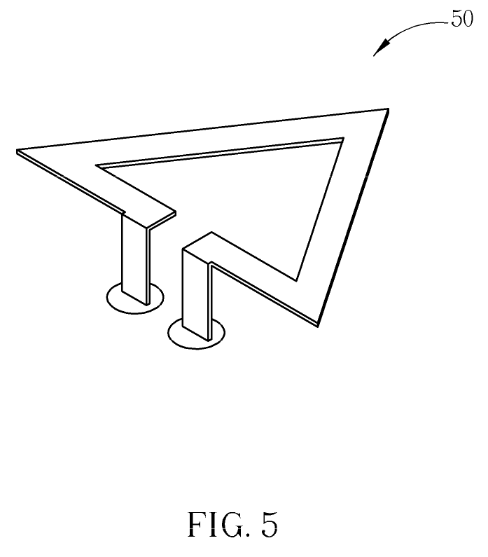

In FIG. 3, the shape of the metal bar 304 surrounded is a circular shape. In fact, the shape of the metal bar 304 is not a limitation of the present invention, and can be other shapes. For example, FIG. 4 to FIG. 6 are schematic diagrams of loop antennas 40, 50 and 60 according to embodiments of the present invention. The loop antennas 40, 50 and 60 derive from the loop antenna 30 with differences of square shape, triangular shape, and symmetrical meander shape. Certainly, other shapes can also be applied for the present invention.

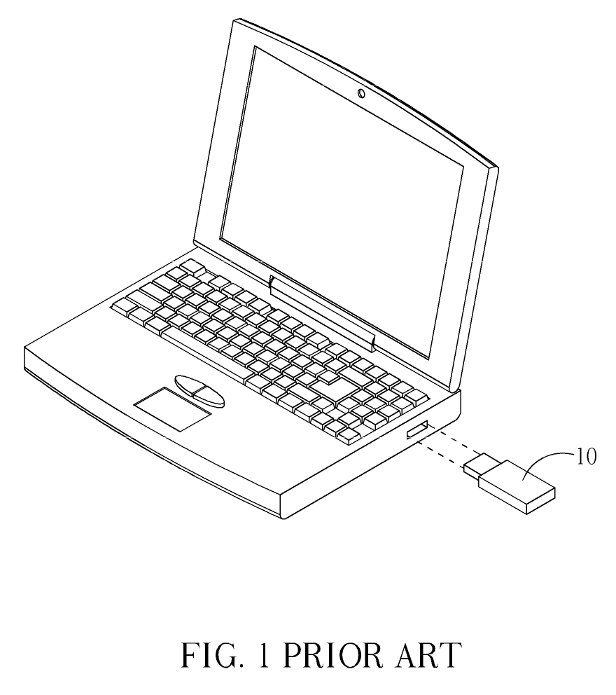

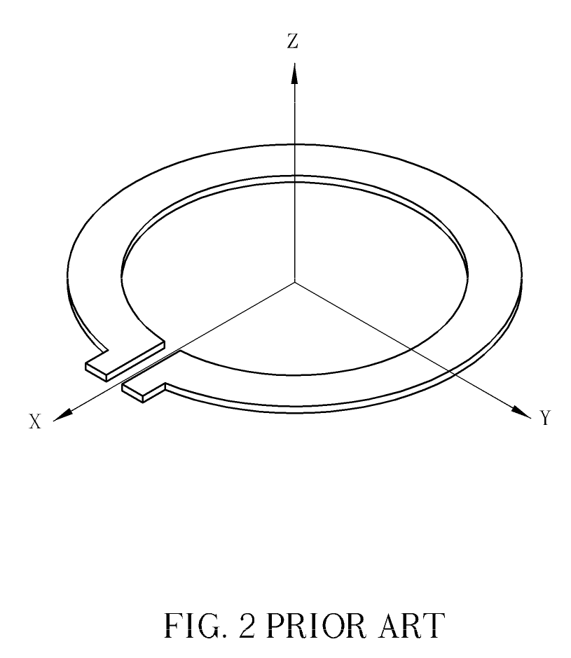

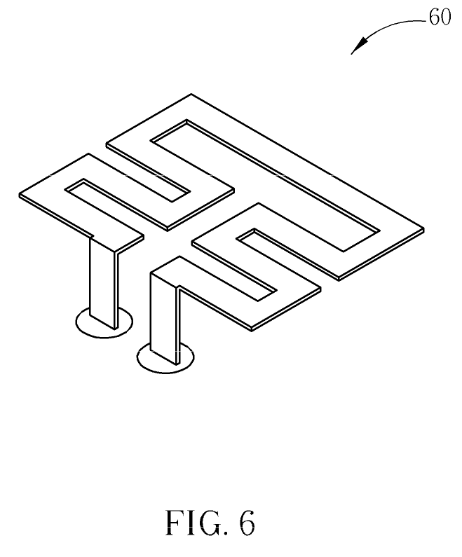

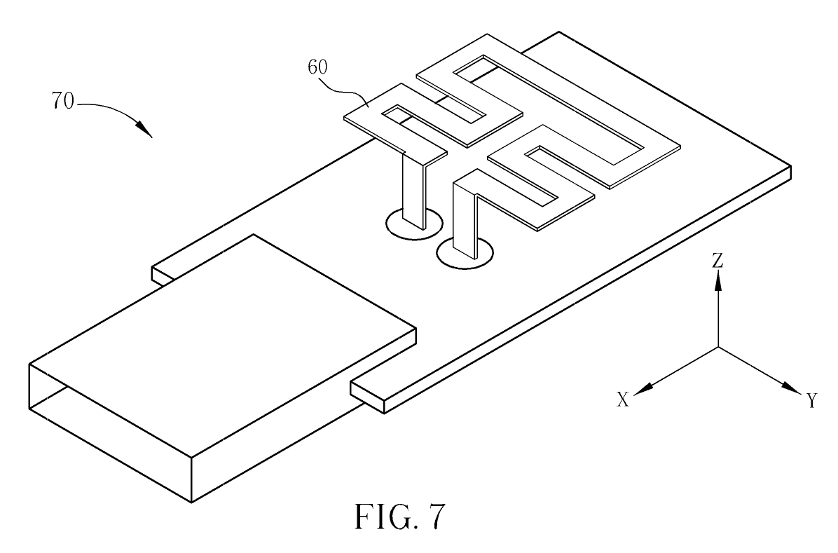

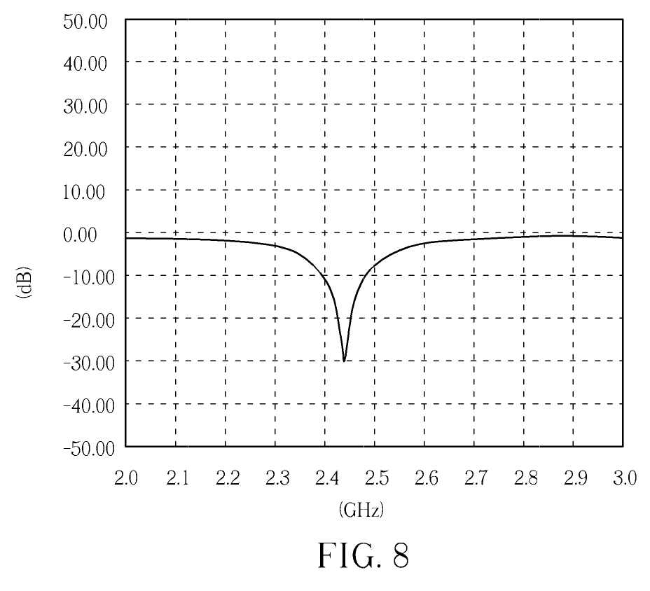

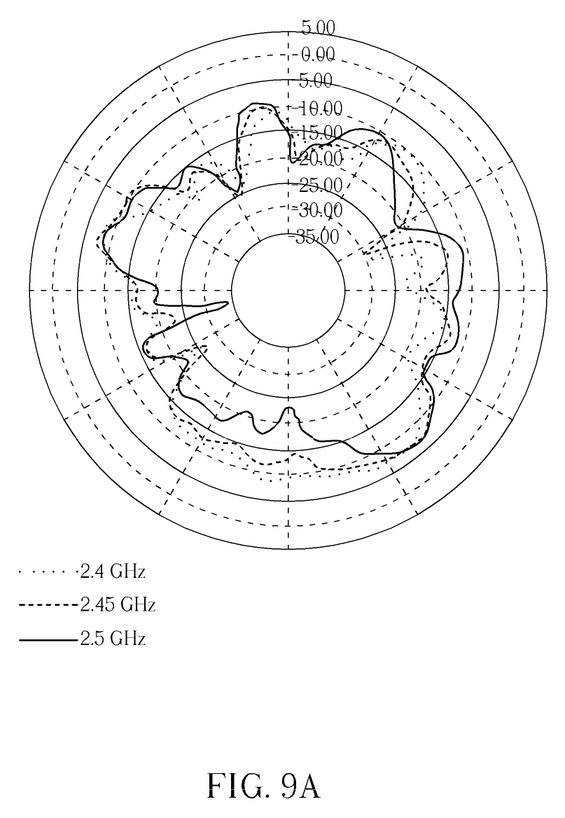

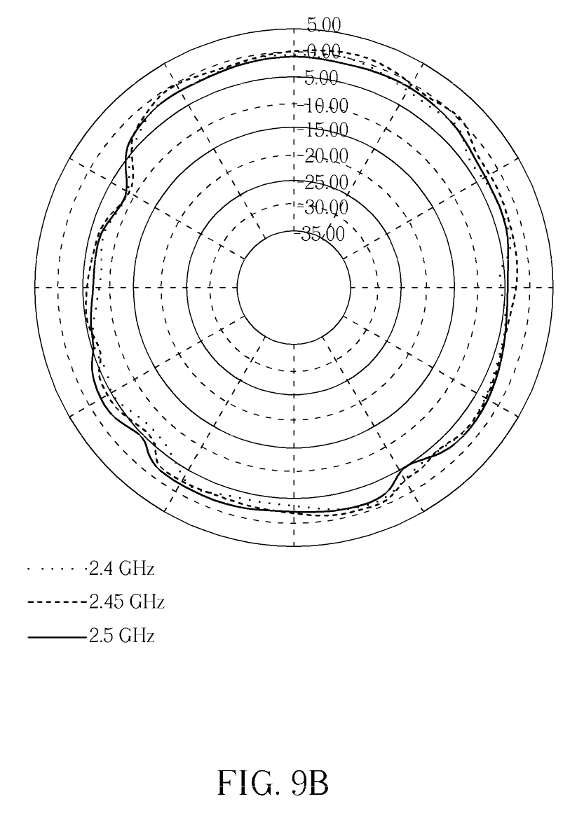

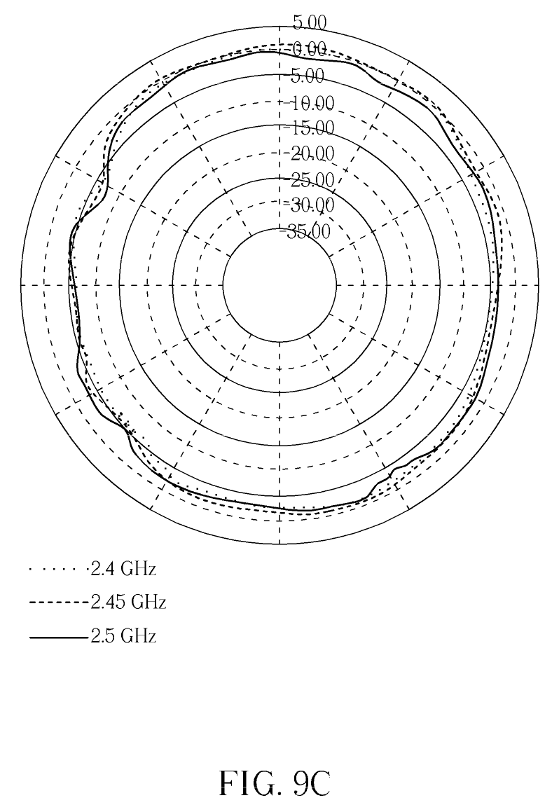

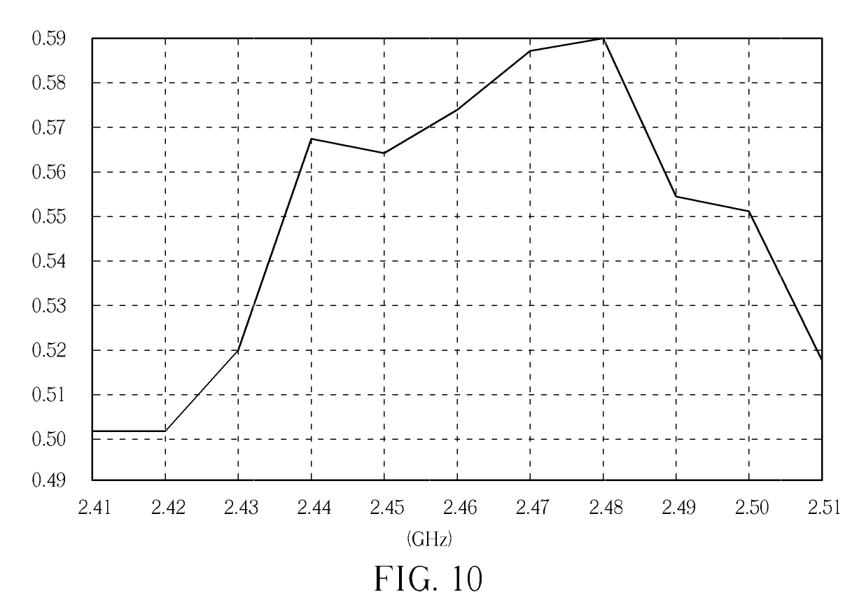

Therefore, the present invention can counterbalance the horizontal currents, and keep the vertical currents, to make the loop antenna to become vertically polarized. Under such circumstance, if the loop antenna of the present invention is applied to the wireless adapter shown in FIG. 1, the size can be reduced and the vertical gain can be enhanced. For example, please refer to FIG. 7. FIG. 7 is a schematic diagram of a wireless adapter 70. The loop antenna 60 shown in FIG. 6 is formed in the wireless adapter 70 for transmitting and receiving signals of WLAN (Wireless Local Area Network), while other elements are omitted and not shown in FIG. 7. In such situation, when the wireless adapter 70 replaces the wireless adapter 10 for the example of FIG. 1, corresponding radiation characteristics are shown in FIG. 8, FIG. 9A to 9C, and FIG. 10. FIG. 8 is a return loss diagram of the wireless adapter 70. FIG. 9A is a schematic diagram of a horizontal gain (generally called Gain Phi) of the wireless adapter 70 on the x-y plane. FIG. 9B is a schematic diagram of a vertical gain (generally called Gain Theta) of the wireless adapter 70 on the x-y plane. FIG. 9C is a schematic diagram of a total gain of the wireless adapter 70 on the x-y plane. FIG. 10 is a schematic diagram of radiation efficiency of the wireless adapter 70. Therefore, as shown in FIG. 8 to FIG. 10, via the loop antenna 60, the forming space required by the wireless adapter 70 can be reduced, and vertical efficiency can be enhanced due to vertical polarization.

Note that, the wireless adapter 70 shown in FIG. 7 is an embodiment of the present invention, and those skilled in the art can make modifications and alterations according to different requirements. For instance, in order to enhance reception and transmission efficiency of the wireless adapter 70, an area of a bottom board of the wireless adapter 70 should be larger than a projection area of the loop antenna 60; or, a hole or a slot on the bottom board is generated to make electric wavelength close to or greater than λ/4. These skills are well-known for the industry, and the main purpose is to further enhance antenna efficiency instead of confining the present invention.

In summary, in the present invention, the total length of the loop antenna is λ/2 to form the open circuit at the center, so as to (nearly) cancel out horizontal currents. Meanwhile, via the metal arms in vertical, only vertical currents of the loop antenna are left, so as to enhance the vertical gain, and reach the purpose of vertical polarization.

Those skilled in the art will readily observe that numerous modifications and alterations of the device and method may be made while retaining the teachings of the invention.

What is claimed is:

1. A loop antenna for a wireless network comprising:
a feeding terminal, for receiving a feeding signal;
a shorting-to-ground terminal, for providing grounding;
a metal bar, formed on a first plane and surrounding a center point;
a first metal arm, formed on a second plane associated with the first plane and coupled between an terminal of the metal bar and the feeding terminal; and
a second metal arm, formed on a third plane associated with the first plane and coupled between another terminal of the metal bar and the shorting-to-ground terminal.

2. The loop antenna of claim 1, wherein the first plane and the second plane are perpendicular to one another.

3. The loop antenna of claim 1, wherein the first plane and the third plane are perpendicular to one another.

4. The loop antenna of claim 1, wherein the second plane and the third plane are parallel.

5. The loop antenna of claim 1, wherein the metal bar surrounding the center forms a geometric shape.

6. The loop antenna of claim 5, wherein the geometric shape is a circular shape.

7. The loop antenna of claim 5, wherein the geometric shape is a square shape.

8. The loop antenna of claim 5, wherein the geometric shape is a triangular shape.

9. The loop antenna of claim 5, wherein the geometric shape is symmetrical to a line.

10. The loop antenna of claim 5, wherein the geometric shape is a meander shape.

11. The loop antenna of claim 1, wherein a total length of the metal bar, the first metal arm, and the second metal arm is 0.5 times of a wavelength of the feeding signal.

12. The loop antenna of claim 1, wherein a length of the first metal arm is equal to a length of the second metal arm.

13. The loop antenna of claim 12, wherein the lengths of both the first metal arm and the second metal arm are 0.05 times of a wavelength of the feeding signal.

14. The loop antenna of claim 1, wherein electric current directions of both the first metal arm and the second metal arm are toward the metal bar.

15. The loop antenna of claim 1, wherein the feeding terminal and the shorting-to-ground terminal are formed on a printed circuit board.
